(19) United States
(12) Patent Application Publication
(10) Pub. No.: US 2024/0386460 A1
(43) Pub. Date: Nov. 21, 2024

(54) AI-BASED AUTOMATIC ADVERTISEMENT EVALUATION SYSTEM

(71) Applicant: SURVEY PEOPLE CO., LTD., Seoul (KR)

(72) Inventor: Min Hee CHO, Seoul (KR)

(73) Assignee: SURVEY PEOPLE CO., LTD., Seoul (KR)

(21) Appl. No.: 18/271,153

(22) PCT Filed: Dec. 20, 2022
(86) PCT No.: PCT/KR2022/020779

§ 371 Date: Jul. 6, 2023

(51) Int. Cl. G06Q 30/0242; G06Q 30/0601

(52) U.S. Cl. CPC G06Q 30/0245; G06Q 30/0633

(57) ABSTRACT

An AI-based automatic advertisement evaluation system includes a survey setup unit configured to model a global panel advertisement pre-evaluation item list, a survey information collection unit configured to collect global panel advertisement evaluation data for a survey list provided by the survey setup unit, an advertisement evaluation analysis unit configured to analyze the global panel advertisement evaluation data collected by the survey information collection unit based on AI, and an advertisement result display unit configured to visualize data analysis results of the advertisement evaluation analysis unit.

### CROSS-REFERENCE TO PRIOR APPLICATION

This Application is a National Stage Application of PCT International Application No. PCT/KR2022/020779 (filed on Dec. 20, 2022), which is hereby incorporated by reference in its entirety.

### BACKGROUND

The present invention relates to an artificial intelligence (AI)-based automatic advertisement evaluation system, and more specifically, to an AI-based automatic advertisement evaluation system for analyzing a difference between types of advertisement evaluator businesses on the basis of a database (DB) provided by a council of advertising and statistics experts and an advertisement evaluation platform DB and providing a platform for automatically generating advertisement evaluation data for each type of advertisement evaluator business.

With the development of mobile platform technology, the form of advertising is changing into in-app advertisements in which search advertisements and display advertisements on the mobile web are inserted into apps. The development of mobile platform advertisement technology is significantly increasing advertising sales effects. Also, an experiment involving creating an advertisement and inserting it into an exclusive advertising app, a game app, and a point service app showed that the reliability of the advertisement is connected to offline, and thus, when users earn points from purchasing products, it leads to stability about the reliability of the advertisement as well as the advertising effect.

Therefore, studies and evaluation methods of advertising effects in a mobile advertising market are considered to enable development of various methods for advertising exposure and also provide a good opportunity to raise the need to develop an app that can filter data to restrict gambling or sexual advertisements. Developing an optimized mobile-based advertising app will provide both advertisers and users in the rapidly changing advertising market with reliability and a cost reduction effect for advertisers and will be a good opportunity to induce active user participation from refunding support.

According to existing inventions, such as that disclosed in Korean Patent Publication No. 10-2451020, practically in an advertisement production process, advertising ideas which are suitable from an expert's point of view may not be delivered to actual customers, it may be difficult for an advertisement production company to persuade a client in the case of conflicting opinions with the client despite a well-produced advertisement, or it may be difficult to coordinate disagreements not only with the client but also within the production team. In the above case, the advertising effect is degraded, which is problematic.

Accordingly, the need to check main indicators required for advertisement production in order to make good decisions on how to produce an advertisement, including on an advertising concept, a creative factor, a tone, a manner, etc., is increasing, and the importance of an advertisement evaluation system is increasing accordingly.

Therefore, a systemic technology for pre-analyzing advertising content response and advertising effects is being developed to evaluate advertisements in advance before launching the advertisements. However, this technology involves a platform that analyzes advertising services on the basis of advertisement evaluation data in accordance with survey questions previously set by the original panel, and thus it is not possible to collect various types of evaluation data from various social groups (panels). Accordingly, there is a limitation in data build-up, and thus only uniformized analysis result data is derived. Also, various types of advertisement evaluation analysis result data are neither classified by a user's needs nor visually derived to be understood at a glance.

### SUMMARY

The present invention is directed to providing an artificial intelligence (AI)-based automatic advertisement evaluation system that builds a database (DB) by collecting various types of evaluation data from various social groups (panels) and visually calculates and provides various types of user-customized advertisement evaluation analysis result data using the DB as an input for an AI function.

One aspect of the present invention provides an artificial intelligence (AI)-based automatic advertisement evaluation system including a survey setup unit configured to model a global panel advertisement pre-evaluation item list, a survey information collection unit configured to collect global panel advertisement evaluation data for a survey list provided by the survey setup unit, an advertisement evaluation analysis unit configured to analyze the global panel advertisement evaluation data collected by the survey information collection unit based on AI, and an advertisement result display unit configured to visualize data analysis results of the advertisement evaluation analysis unit.

The survey setup unit may include a pre-evaluation item list setup unit configured to set up a global panel advertisement pre-evaluation item list for advertising videos or images based on a developer interface in advance and a user evaluation item list setup unit configured to receive and sample an additional global panel advertisement evaluation item list for advertising videos or images based on a user interface.

The survey setup unit may further include an automatic evaluation item list sampling unit configured to calculate survey times, sexes, ages, and jobs of global panels through an AI user analysis algorithm to which global panel data shared through a global network is input, and automatically sample one or more global panel advertisement pre-evaluation item lists.

The global panel data may include personal information data shared through social network service (SNS) networks of Korean, Chinese, Japanese, American, and Vietnamese advertisement evaluators.

The survey information collection unit may include a preceding database (DB) unit configured to build a DB by collecting global panel evaluation data for an advertisement evaluation list set up by the pre-evaluation item list setup unit and the user evaluation item list setup unit.

The survey information collection unit may further include an automatic DB unit configured to build a DB by collecting global panel evaluation data for an advertisement evaluation list which is automatically generated and customized for global panels from the automatic evaluation item list sampling unit.

The advertisement evaluation analysis unit may include a customized interface analysis unit configured to provide a user-customized interface and calculate country- and business-specific vector-size data (norm data) to be input to an AI advertisement evaluation algorithm from the global panel advertisement evaluation data.

The customized interface analysis unit may calculate a total amount of time and cost expected for advertisement evaluation through the AI advertisement evaluation algorithm.

The advertisement evaluation analysis unit may further include a competitor advertisement comparative analysis unit configured to compare the global panel advertisement evaluation data for an advertisement to be evaluated collected by the survey information collection unit with advertisement evaluation results of the same type of business or overall advertisement evaluation results which are already stored.

The competitor advertisement comparative analysis unit may derive relative evaluation analysis results of the advertisement to be evaluated collected by the survey information collection unit with respect to advertisement norm data of five or more competitors in the same project field as the advertisement to be evaluated.

The advertisement evaluation analysis unit may further include an AI evaluation digitization unit configured to derive an evaluator expression analysis image using an evaluator face recognition image sensed through a webcam as an input for the AI advertisement evaluation algorithm and digitize the global panel advertisement evaluation data into a score according to score matching vector values for evaluator expression analysis images.

The advertisement result display unit may include a graph calculation unit configured to calculate and visualize the data analysis results of the advertisement evaluation analysis unit as a graph and a face recognition result data calculation unit configured to preprocess and visualize user face recognition result score data and user face recognition result image data.

The graph calculation unit may include a word cloud, a main subject visualization pie graph, and an applicable business ranking bar graph.

The above-described artificial intelligence (AI)-based automatic advertisement evaluation system has the following effects.

First, it is possible to establish a multi-country and multichannel bidirectional supply-demand network.

Second, it is possible to provide scores reflecting global norm scores for advertisement effect evaluations and business-specific characteristics.

Third, it is possible to provide the initial advertisement effect evaluation service employing an AI technology.

Fourth, it is possible to analyze and visualize a response to a subjective question through natural language processing modeling.

Fifth, it is possible to provide a service for quantifying a physical response to an advertising image through a face recognition AI technology and providing the quantified physical response.

### BRIEF DESCRIPTION OF THE DRAWINGS

FIG. 1 is a block diagram of the present invention.

FIG. 2 is a block diagram of a survey setup unit (10) according to an embodiment of the present invention.

FIG. 3 is a block diagram of a survey information collection unit (20) according to an embodiment of the present invention.

FIG. 4 is a block diagram of an advertisement evaluation analysis unit (30) according to an embodiment of the present invention.

FIG. 5 is a block diagram of an advertisement result display unit (40) according to an embodiment of the present invention.

FIGS. 6 and 7 are example diagrams of the advertisement result display unit (40) according to an embodiment of the present invention.

### DETAILED DESCRIPTION

An artificial intelligence (AI)-based automatic advertisement evaluation system according to embodiments of the present invention will be described in detail below with reference to the accompanying drawings. Since the present invention can be modified in various ways and have several forms, particular embodiments will be illustrated in the drawings and described in detail. However, this is not intended to limit the present invention to particular modes of disclosure, and it is to be appreciated that all changes, equivalents, and substitutes that do not depart from the spirit and technical scope of the present invention are included in the present invention. In the description of each drawing, like reference numerals refer to like elements. In the accompanying drawings, sizes of structures are illustrated to be expanded compared to actual sizes for clarity of the present invention or to be shrunk for understanding of schematic configurations.

The terms “first,” “second,” etc. may be used for describing various components, but the components should not be limited thereto. The terms are used only for the purpose of distinguishing one component from another. For example, a first component may be termed a second component, and similarly, a second component may be termed a first component without departing from the scope of the present invention. Meanwhile, unless otherwise defined, all terms used herein, including technical or scientific terms, have the same meaning as commonly understood by those skilled in the technical field to which the present invention pertains. Terms such as those defined in commonly used dictionaries should be interpreted as having a meaning consistent with the meaning in the context of the related technology and should not be interpreted with an ideal or excessively formal meaning unless explicitly defined in this application.

The present invention relates to an AI-based automatic advertisement evaluation system, and more specifically, to an AI-based automatic advertisement evaluation system for analyzing a difference between types of advertisement evaluator businesses on the basis of a database (DB) provided by a council of advertising and statistics experts and an advertisement evaluation platform DB and providing a platform for automatically generating advertisement evaluation data for each type of advertisement evaluator business.

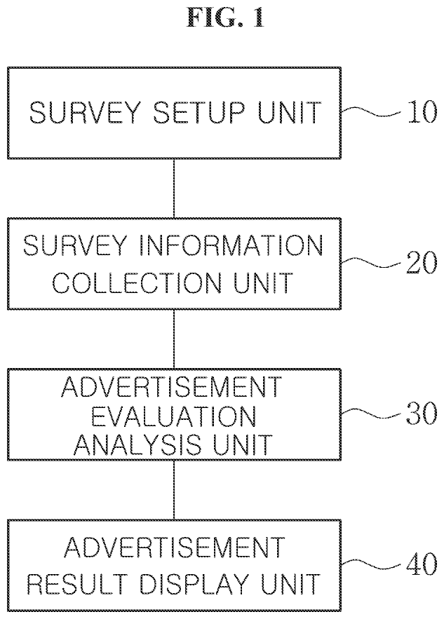

FIG. 1 is a block diagram of the present invention.

Referring to FIG. 1, an AI-based automatic advertisement evaluation system includes a survey setup unit 10, a survey information collection unit 20, an advertisement evaluation analysis unit 30, and an advertisement result display unit 40. The survey setup unit 10 models a global panel advertisement pre-evaluation item list. The survey information collection unit 20 collects global panel advertisement evaluation data for a survey list provided by the survey setup unit 10. The advertisement evaluation analysis unit 30 analyzes the global panel advertisement evaluation data collected by the survey information collection unit 20 based on AI. The advertisement result display unit 40 visualizes data analysis results of the advertisement evaluation analysis unit 30.

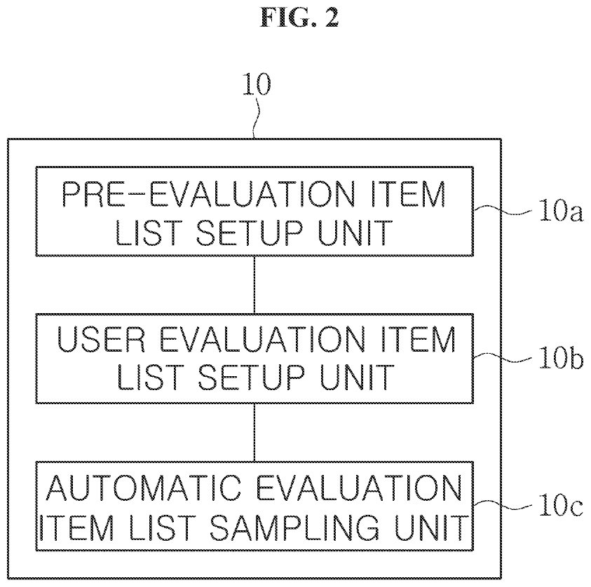

FIG. 2 is a block diagram of the survey setup unit 10 according to the embodiment of the present invention.

Referring to FIG. 2, the survey setup unit 10 includes a pre-evaluation item list setup unit 10a, a user evaluation item list setup unit 10b, and an automatic evaluation item list sampling unit 10c. The pre-evaluation item list setup unit 10a sets up a global panel advertisement pre-evaluation item list for advertising videos or images based on a developer interface in advance. The user evaluation item list setup unit 10b receives and samples an additional global panel advertisement evaluation item list for advertising videos or images based on a user interface. The automatic evaluation item list sampling unit 10c calculates survey times, sexes, ages, and jobs of global panels through an AI user analysis algorithm to which global panel data shared through a global network is input, and automatically samples one or more global panel advertisement pre-evaluation item lists. In other words, more specifically, the automatic evaluation item list sampling unit 10c distributes an application programming interface (API) for preprocessing data of not only Korean but four languages and stably and effectively interconnecting panel systems using a technology for building an integrated connection system of country-specific panels. Here, the global panel data includes personal information data shared through social network service (SNS) networks of Korean, Chinese, Japanese, American, and Vietnamese advertisement evaluators.

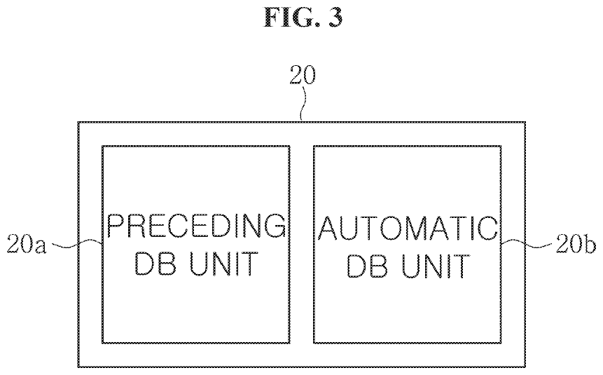

FIG. 3 is a block diagram of the survey information collection unit 20 according to the embodiment of the present invention.

Referring to FIG. 3, the survey information collection unit 20 includes a preceding DB unit 20a and an automatic DB unit 20b. The preceding DB unit 20a collects global panel evaluation data for an advertisement evaluation list set up by the pre-evaluation item list setup unit 10a and the user evaluation item list setup unit 10b and builds a DB. In other words, more specifically, the preceding DB unit 20a includes global panel evaluation data related to the global panel advertisement pre-evaluation item list set up for advertising videos or images based on the developer interface by the pre-evaluation item list setup unit 10a and global panel evaluation data related to the additional global panel advertisement evaluation item list received and sampled for advertising videos or images based on the user interface by the user evaluation item list setup unit 10b. Also, the automatic DB unit 20b collects global panel evaluation data for an advertisement evaluation list which is automatically generated and customized for global panels from the automatic evaluation item list sampling unit 10c and builds a DB.

In other words, more specifically, the automatic DB unit 20b according to the embodiment of the present invention calculates survey times, sexes, ages, and jobs of global panels through an AI user analysis algorithm to which automatically sampled global panel data shared through the global network is input, and generates one or more global panel advertisement pre-evaluation item lists.

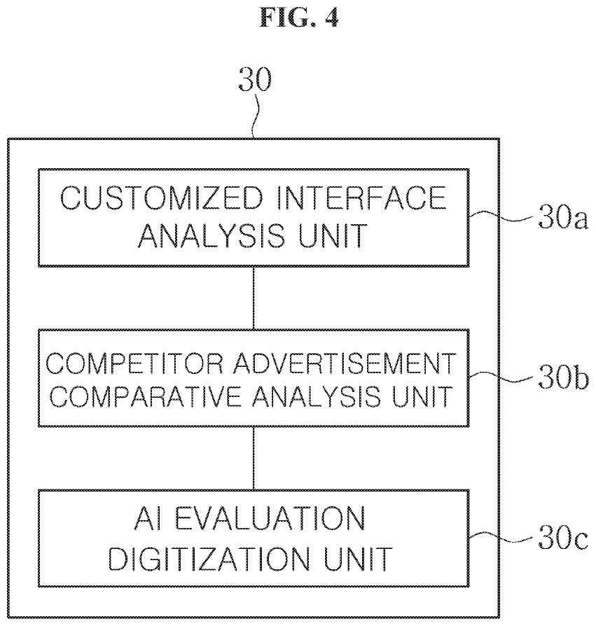

FIG. 4 is a block diagram of the advertisement evaluation analysis unit 30 according to the embodiment of the present invention.

Referring to FIG. 4, the advertisement evaluation analysis unit 30 includes a customized interface analysis unit 30a, a competitor advertisement comparative analysis unit 30b, and an AI evaluation digitization unit 30c. The customized interface analysis unit 30a provides a user-customized interface, calculates country- and business-specific vector-size data (norm data) to be input to an AI advertisement evaluation algorithm from the global panel advertisement evaluation data, and calculates a total amount of time and cost expected for advertisement evaluation through the AI advertisement evaluation algorithm. The competitor advertisement comparative analysis unit 30b compares the global panel advertisement evaluation data for an advertisement to be evaluated collected by the survey information collection unit 20 with advertisement evaluation results of the same type of business or overall advertisement evaluation results which are already stored. In other words, more specifically, the competitor advertisement comparative analysis unit 30b derives relative evaluation analysis results of the advertisement to be evaluated collected by the survey information collection unit 20 with respect to advertisement norm data of five or more competitors in the same project field as the advertisement to be evaluated. Also, the customized interface analysis unit 30a builds up country-specific norm data on the basis of advertisement evaluation data of the five countries through the API for stably and effectively interconnecting panel systems using a technology for building an integrated connection system of country-specific panels on the basis of data of Korean and four languages preprocessed by the automatic evaluation item list sampling unit 10c and provides a norm score which is a reference for evaluation results. Here, an evaluation index reflecting a business-specific characteristic is provided through business-specific data analysis. Also, the competitor advertisement comparative analysis unit 30b compares the global panel advertisement evaluation data for the advertisement to be evaluated collected by the survey information collection unit 20 with the global panel advertisement evaluation data for a competitor advertisement.

In the case of advertisement evaluation based on the global panel advertisement pre-evaluation item list, the AI evaluation digitization unit 30c derives an evaluator expression analysis image using an evaluator face recognition image sensed through a webcam as an input for the AI advertisement evaluation algorithm and digitizes the global panel advertisement evaluation data into a score according to score matching vector values for evaluator expression analysis images. In other words, more specifically, the AI evaluation digitization unit 30c analyzes subjective response data related to advertisement-related impact keywords and sentence data of satisfaction, happiness, and joy by performing natural language processing on the subjective response data through an AI technology employing a research-field algorithm in which about 40,000 pieces of question data having the problem of cold start are applied to a convolutional neural network (CNN) model using an item-centered cooperation filtering model based on a question recommendation service technology.

Here, the advertisement evaluation analysis unit 30 according to the embodiment of the present invention provides analysis visualization service through multilingual natural language processing modeling and analyzes text data of open-ended questions which are user-defined questions in a user survey of advertisements. In other words, in the customized interface analysis unit 30a, it is necessary to process a large amount of open-ended user-defined question data which is the source data into an analyzable form, and thus the open-ended user-defined question data is transmitted to a multilingual text preprocessing module and preprocessed. Also, data which is digitized after the AI evaluation digitization unit 30c completes token embedding, is converted into a meaningful value through stage-specific algorithms of an AI-based analysis module.

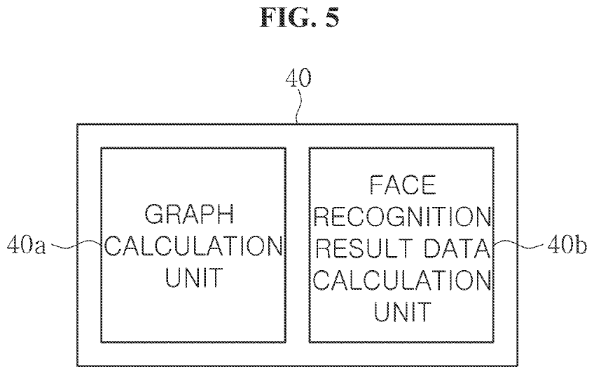

FIG. 5 is a block diagram of the advertisement result display unit 40 according to the embodiment of the present invention.

Referring to FIG. 5, the advertisement result display unit 40 includes a graph calculation unit 40a and a face recognition result data calculation unit 40b. The graph calculation unit 40a calculates and visualizes the data analysis results of the advertisement evaluation analysis unit 30 as a graph. Here, the graph calculation unit 40a includes a word cloud, a main subject visualization pie graph, and an applicable business ranking bar graph. The face recognition result data calculation unit 40b preprocesses and visualizes user face recognition result score data and user face recognition result image data. Here, the advertisement result display unit 40 combines refined text data with a prediction result of an AI-based survey analysis module and visualizes the combination. According to the embodiment of the present invention, the face recognition result data calculation unit 40b visualizes the analysis data of the AI evaluation digitization unit 30c obtained by performing natural language processing on subjective response data related to advertisement-related impact keywords and sentence data of satisfaction, happiness, and joy through the AI technology. In other words, this is a service of quantifying a physical response to an advertising image into a facial coding score through a face recognition analysis AI technology and visually providing the facial coding score.

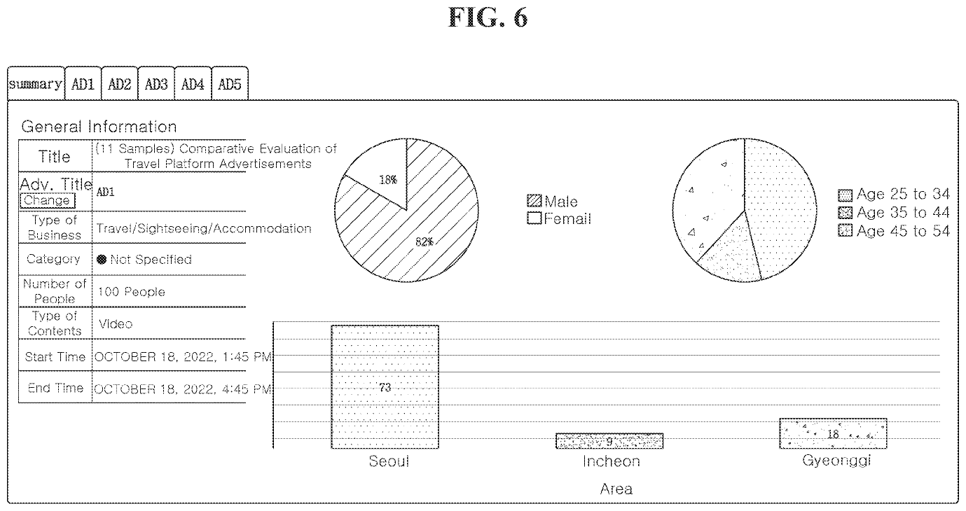

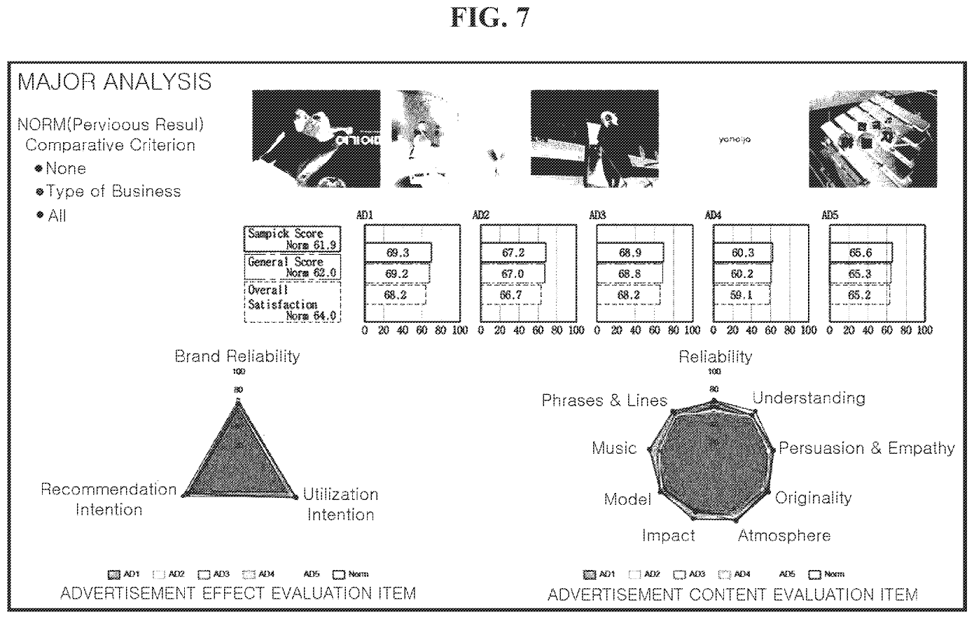

FIGS. 6 and 7 are example diagrams of the advertisement result display unit 40 according to the embodiment of the present invention.

Referring to FIGS. 6 and 7, the advertisement evaluation analysis unit 30 includes the customized interface analysis unit 30a, the competitor advertisement comparative analysis unit 30b, and the AI evaluation digitization unit 30c. The customized interface analysis unit 30a provides a user-customized interface, calculates country- and business-specific vector-size data (norm data) to be input to the AI advertisement evaluation algorithm from the global panel advertisement evaluation data, and calculates a total amount of time and cost expected for advertisement evaluation through the AI advertisement evaluation algorithm. Also, the advertisement result display unit 40 derives a graph from analysis result values of the advertisement evaluation analysis unit 30. In other words, more specifically, when the advertisement evaluation analysis unit 30 performs advertisement (AD) evaluation analysis regarding N advertisements on an advertisement score having the highest sex/age- and area-specific Sampick score, an advertisement score having the lowest sex/age- and area-specific Sampick score, an advertisement score having the highest general score, an advertisement score having the lowest general score, an advertisement score having the highest overall satisfaction, and an advertisement score having the lowest satisfaction, the advertisement result display unit 40 displays a norm score statistics graph for the analysis results (scores).

In particular, the advertisement evaluation analysis unit 30 derives comparative analysis result values based on a maximum of five competitor advertisements, and the advertisement result display unit 40 derives a triangular graph as a result of comparative analysis on advertising effect evaluation items including brand reliability, recommendation intention, and utilization intention for AD1, AD2, AD3, AD4, and AD5 and derives a nonagonal comparative analysis result graph of reliability, understanding, persuasion and empathy, originality, atmosphere, impact, model, music, phrases, and lines for AD1, AD2, AD3, AD4, and AD5.

The present invention provides an AI-based automatic advertisement evaluation system that builds a DB by collecting various types of evaluation data from various social groups (panels) and visually calculates and provides various types of user-customized advertisement evaluation analysis result data using the DB as an input for an AI function. The above-described AI-based automatic advertisement evaluation system has the following effects. First, it is possible to establish a multi-country and multichannel bidirectional supply-demand network. Second, it is possible to provide scores reflecting global norm scores for advertisement effect evaluations and business-specific characteristics. Third, it is possible to provide the initial advertisement effect evaluation service employing an AI technology. Fourth, it is possible to analyze and visualize a response to a subjective question through natural language processing modeling. Fifth, it is possible to provide a service for quantifying a physical response to an advertising image through a face recognition AI technology and providing the quantified physical response.

Although the present invention has been described above with reference to exemplary embodiments thereof, those skilled in the corresponding technical field or those of ordinary skill in the corresponding technical field should appreciate that various modifications and alterations can be made without departing from the spirit and technical scope of the present invention described in the following claims.

The present invention relates to an automatic advertisement evaluation platform and can be applied to the advertising industry market. In other words, since most surveys on advertisement effects generally involve relative evaluation, the automatic advertisement evaluation platform for relatively evaluating a target advertisement on the basis of various competitor advertisements is built so that relative evaluations on advertisement effects can be optimally made through the automatic advertisement evaluation platform. In addition, the present invention can be applied to the industrial field of survey data analysis and survey database (DB) construction as an artificial intelligence (AI)-based survey item recommendation service algorithm technology based on a user business.

1. An artificial intelligence (AI)-based automatic advertisement evaluation system, comprising:
a survey setup unit configured to model a global panel advertisement pre-evaluation item list;
a survey information collection unit configured to collect global panel advertisement evaluation data for a survey list provided by the survey setup unit;
an advertisement evaluation analysis unit configured to analyze the global panel advertisement evaluation data collected by the survey information collection unit based on AI; and
an advertisement result display unit configured to visualize data analysis results of the advertisement evaluation analysis unit.

2. The AI-based automatic advertisement evaluation system of claim 1, wherein the survey setup unit comprises:
a pre-evaluation item list setup unit configured to set up a global panel advertisement pre-evaluation item list for advertising videos or images based on a developer interface in advance; and
a user evaluation item list setup unit configured to receive and sample an additional global panel advertisement evaluation item list for advertising videos or images based on a user interface.

3. The AI-based automatic advertisement evaluation system of claim 2, wherein the survey setup unit further comprises an automatic evaluation item list sampling unit configured to calculate survey times, sexes, ages, and jobs of global panels through an AI user analysis algorithm to which global panel data shared through a global network is input, and automatically sample one or more global panel advertisement pre-evaluation item lists.

4. The AI-based automatic advertisement evaluation system of claim 3, wherein the global panel data includes personal information data shared through social network service (SNS) networks of Korean, Chinese, Japanese, American, and Vietnamese advertisement evaluators.

5. The AI-based automatic advertisement evaluation system of claim 2, wherein the survey information collection unit comprises a preceding database (DB) unit configured to build a DB by collecting global panel evaluation data for an advertisement evaluation list set up by the pre-evaluation item list setup unit and the user evaluation item list setup unit.

6. The AI-based automatic advertisement evaluation system of claim 3, wherein the survey information collection unit further comprises an automatic database (DB) unit configured to build a DB by collecting global panel evaluation data for an advertisement evaluation list which is automatically generated and customized for global panels from the automatic evaluation item list sampling unit.

7. The AI-based automatic advertisement evaluation system of claim 1, wherein the advertisement evaluation analysis unit comprises a customized interface analysis unit configured to provide a user-customized interface and calculate country- and business-specific vector-size data (norm data) to be input to an AI advertisement evaluation algorithm from the global panel advertisement evaluation data.

8. The AI-based automatic advertisement evaluation system of claim 7, wherein the customized interface analysis unit calculates a total amount of time and cost expected for advertisement evaluation through the AI advertisement evaluation algorithm.

9. The AI-based automatic advertisement evaluation system of claim 1, wherein the advertisement evaluation analysis unit further comprises a competitor advertisement comparative analysis unit configured to compare the global panel advertisement evaluation data for an advertisement to be evaluated collected by the survey information collection unit with advertisement evaluation results of the same type of business or overall advertisement evaluation results which are already stored.

10. The AI-based automatic advertisement evaluation system of claim 9, wherein the competitor advertisement comparative analysis unit derives relative evaluation analysis results of the advertisement to be evaluated collected by the survey information collection unit with respect to advertisement norm data of five or more competitors in the same project field as the advertisement to be evaluated.

11. The AI-based automatic advertisement evaluation system of claim 7, wherein the advertisement evaluation analysis unit further comprises an AI evaluation digitization unit configured to derive an evaluator expression analysis image using an evaluator face recognition image sensed through a webcam as an input for the AI advertisement evaluation algorithm and digitize the global panel advertisement evaluation data into a score according to score matching vector values for evaluator expression analysis images.

12. The AI-based automatic advertisement evaluation system of claim 1, wherein the advertisement result display unit comprises:
a graph calculation unit configured to calculate and visualize the data analysis results of the advertisement evaluation analysis unit as a graph; and
a face recognition result data calculation unit configured to preprocess and visualize user face recognition result score data and user face recognition result image data.

13. The AI-based automatic advertisement evaluation system of claim 11, wherein the graph calculation unit includes a word cloud, a main subject visualization pie graph, and an applicable business ranking bar graph.
